(19) United States
(12) Patent Application Publication
(10) Pub. No.: US 2024/0232678 A9
(43) Pub. Date: Jul. 11, 2024

(54) METHOD AND APPARATUS FOR GENERATING A DATASET FOR TRAINING A CONTENT DETECTION MACHINE LEARNING MODEL

(71) Applicant: UAB 360 IT, Vilnius (LT)

(72) Inventors: Aleksandr Sevcenko, Vilnius (LT); Mantas Briliauskas, Vilnius (LT)

(21) Appl. No.: 17/969,168

(22) Filed: Oct. 19, 2022

(51) Int. Cl. G06N 20/00

(52) U.S. Cl. CPC G06N 20/00

(57) ABSTRACT

A method and apparatus for generating a dataset for training a content detection machine learning model. The method applies one or more transforms to a content containing bitstream that produce feature tensors representing the content, labels the feature tensors by type of content, stores feature tensors and labels in a dataset. The dataset my be used to train a content detection machine learning model. The model may be exported to content detectors to identify and classify bitstream content contained in other bitstreams.

### FIELD

The present invention relates generally to content detection, and more particularly, to a method and apparatus for generating a dataset for training a content detection machine learning model.

### BACKGROUND

Detection of various types of content (e.g., executable code, text, video, audio, image, and the like) that is contained in a bitstream can be tedious and complicated. Presently, specific samples of content and related metadata are stored in large databases and the samples/metadata are compared to bitstreams to identify matches between the samples/metadata and the contents of the bitstream. Because of the substantial amount of processing that is required such matching techniques are generally performed off-line. Processing off-line is not viable when attempting to detect and remove malicious content such as malware or viruses.

Malware (malicious software) is ubiquitous on the Internet in the form of ransomware, computer viruses, worms, trojans, spyware, keyloggers, and so on. Malware may be intended to impact the functionality of computers and computer networks by interfering with security, privacy, and/or hardware functionality. Most malware is inadvertently downloaded by a user from the internet. The malware may be hidden in what looks to be a legitimate application or may be attached to a file that is downloaded as a bitstream.

Malware detection software searches computer files in memory (e.g., persistent memory such as hard drives, solid state memory, memory cards, and the like and/or non-persistent memory such as random access memory) and/or bitstreams as they are downloaded to identify malware before it is activated. The process of building malware identification datasets is tedious. The public and private networks must be constantly monitored for new malware or previous malware that has been adapted to avoid detection. Once identified, the malware is scrutinized to determine “samples”—typically portions of executable code—to be used to identify the malware. The samples are placed in malware datasets to be used to identify when the malware is embedded in applications or files.

Currently, the datasets are used as databases for comparison to the content and/or metadata of incoming bitsteams. A binary, byte sequence or pattern match results in malware detection. More recently, the datasets have been used to train neural networks used by malware detectors (models) in an attempt to learn to detect and classify malware executable code that is not specifically contained in the datasets. Either unsupervised or supervised learning approaches may be used; although, supervised learning is more prevalent. In this manner, once trained, the malware detector may anticipate new malware. However, currently the models focus on malicious executable files. Non-executable files are difficult to use in model training and, although non-executable files may contain malicious content, these malicious files are generally not detected with machine learning malware detectors.

Therefore, there is a need for improved methods and apparatuses for generating a dataset for training a content detection machine learning model (especially for detecting malware as content within a bitstream).

### SUMMARY

A method and apparatus for generating a dataset for training a content detection machine learning model. The method applies one or more transforms to a content containing bitstream that produce feature tensors representing the content, labels the feature tensors by type of content, stores feature tensors and labels in a dataset and uses the dataset to train a content detection machine learning model. The model may be exported to content detectors to identify and classify file content contained in other bitstreams.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 illustrates an example of a computer system for generating a dataset for training a content detection machine learning model in accordance with at least one embodiment of the invention.

FIG. 2 is a flow diagram of a method for generating a dataset and using the dataset to train a content detection machine learning model in accordance with at least one embodiment of the present invention.

FIG. 3 depicts a high-level block diagram of a computing device suitable for use with embodiments of the invention to generate a dataset and use the dataset to train a content detection machine learning model in accordance with at least one embodiment of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

The following detailed description describes techniques (e.g., methods, processes, apparatuses, and systems) for generating a dataset for training a content detection machine learning model. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Embodiments consistent with the present invention generate a dataset for training a content detection machine learning model. Once trained, the model may be used to analyze data (e.g., new bitstreams) to extract and classify features of the contents of the bitstreams. These features are classified into types of content, e.g., code, corrupted content, image, video, audio, malware, virus, etc. In a particular embodiment of the trained content detection machine learning model, the classified features may be classified to identify whether any of the extracted features contain malware. In another particular embodiment, the classified features may be classified to identify whether any of the extracted features contain corrupted content (e.g., corrupted executable code). In a further embodiment, the classified features may be used to determine boundaries between different types of content.

To learn feature extraction and classification, the machine learning model is trained using a specially designed dataset. The dataset comprises known labeled content samples (i.e., extracted binary streams of video, audio, code (for various architectures), etc., labeled content features, compressed data, encrypted data, and the like) and labeled features (i.e., feature tensors) formed by applying transformation methods. The transformations may comprise, for example, one or more of transforms that identify a feature within a bitstream and represent the feature as a tensor including, but not limited to, feature vectors, feature metrics, etc. In one embodiment, the transform is at least one vector transform. Specific embodiments may use, for example, vectors of entropies, Laplace transformations (Laplace matrix), n-grams, and the like that forms a feature stream for the content feature. The content detection model may be trained with the feature tensor and labeled dataset such that a trained model may be used to detect various types of content in other bitstreams (not seen before) where the new content has similar features. Details of methods and apparatuses operating in accordance with various embodiments of the invention are described in detail below with respect to the figures.

Although one exemplary embodiment generates a dataset for training a machine learning model for identifying various types of content, in other embodiments, the principles of the invention may be used to generate machine learning models that identify various characteristics of content within bitstreams such as, but not limited to, corrupted files, malware, viruses, and the like. Embodiments of models produced in accordance with this disclosure may find use in reverse engineering executable software to identify certain features or functions of subroutines of the software code.

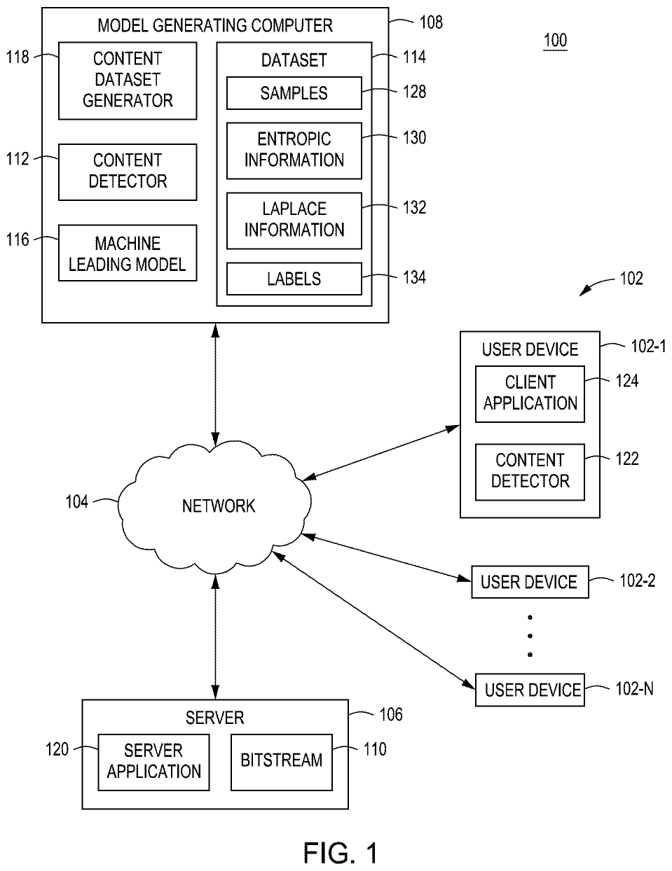

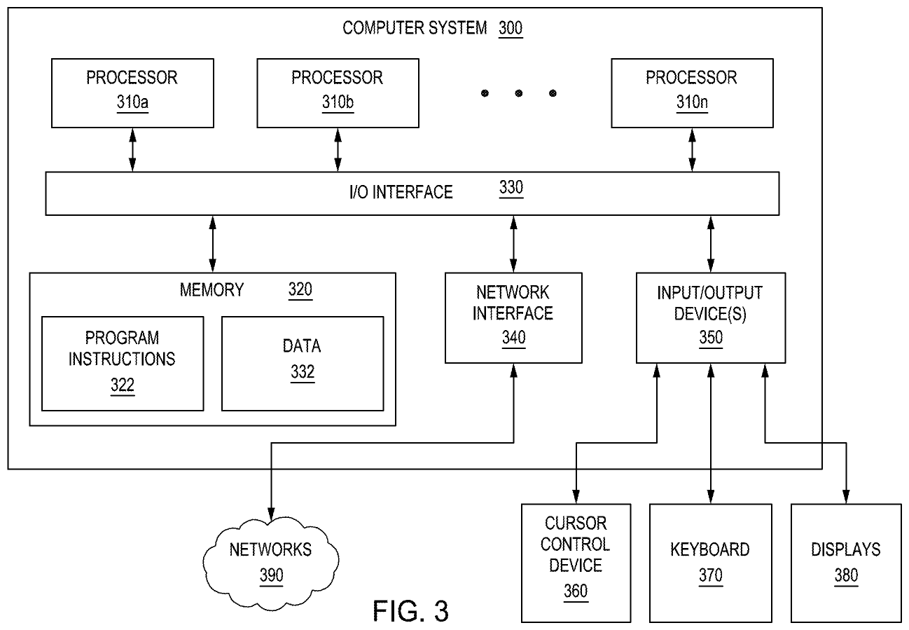

FIG. 1 illustrates an example of a computer system 100 for generating and using a content detection model in accordance with at least one embodiment of the invention. In FIG. 1, the system 100 comprises at least one user device 102, a server 106, and a computer network 104, (e.g., the Internet) connecting the server 106 to the user devices 102. The server 106 is a centralized computing device used to execute the application(s) (server application 120) and communicate file(s) 110 to user devices 102. The bitstream 110 (e.g., binary data streams, byte streams, data streams, data blobs, bit blocks, single bytes, and the like) may contain various data features such as the type of data and its properties. The bitstream 110 is formed by communicating (streaming) a file or other data through the network 104 to one or more of the user devices 102 or the model generating computer 108. The general structure of such a server and/or user device is described in detail below with respect to FIG. 3.

Also connected to the network 104 is a model generating computer 108 configured to generate a content detection dataset 114 and a machine learning model 116 in accordance with the present invention. The dataset 114 is used to train the machine learning model used by the content detector 112 in accordance with a procedure controlled by a dataset generator 118. The model generating computer 108 comprises a malware dataset generator 118 that analyzes various data streams containing content to identify content with specific features to populate a feature dataset 114. The dataset 114 comprises content feature samples 128 as well as feature tensors 126 related to the samples and content labels 134 associated with the feature tensors 126. In one exemplary embodiment, the feature tensors 126 may comprise a vector of entropies that represent feature samples. In other exemplary embodiments, the feature tensors may be a Laplace transform matrix representation of the feature samples. Further exemplary embodiments may use n-grams as feature tensors. The feature tensors may also be combinations of entropic vectors, Laplace matrices and n-grams. In this manner, the dataset 114 may be used to train the machine learning model 116 to recognize and classify specific content features within a bitstream.

User devices 102-1, 102-2, 102-3 . . . 102-N (collectively referred to as user devices 102) communicate through network 104 with the server 106. In some embodiments, user device 102 can be any computing device capable of hosting a content detector 122 (executable software) and a client application 124 (browser or other application that may be affected by or utilize the content). User device 102 may comprise any device that is connected to a network, including, for example, a laptop, a mobile phone, a tablet computer, a desktop computer, a smart device, a router, and other network devices. The client application 124 is a well-known application for accessing and displaying file content, e.g., web content, file(s), etc. delivered by the server 106. Such client applications include browsers such as, but not limited to, Safari®, Chrome®, Explorer®, Firefox®, etc. In other embodiments, the client application is any type of application that may utilize content from a bitstream that is communicated to the user device 102.

In operation, the content detector 122 uses a trained machine learning model (e.g., model 116) that is exported from the model generating computer 108 to the user devices 102. In operation, the model generating computer 108 trains the machine learning model 116. The trained model is then transferred to the content detector 122 used by each user device 102. The files 110 received by the user devices 102 via the network are processed by the content detector 122. The content detector 122 identifies which bit streams in the files contain specific types of content by applying the files to the local machine learning model. In one embodiment, the model identifies and classifies content features that contain malware and removes or isolates the files that are found to contain malware. Occasionally, the model or dataset is updated to reflect additional content features. In other embodiments, the model is trained to identify and classify other forms of content, e.g., audio, video, images, text, corrupted files/code/content, and so on. Generally speaking, if a bitstream feature can be defined, the content reflected by the feature can be transformed into a feature tensor and used to train the machine learning model to identify and classify the feature.

In other embodiments, the dataset comprises samples of content features to be identified along with transform information related to that content feature. This type of dataset may be used to train a machine learning model to recognize various forms of content including, but is not limited to, video, executable code, images, text, audio, corrupted bit streams, and the like. The dataset may also be used to train a model to recognize boundaries between content forms, i.e., transitions from text to video, etc.

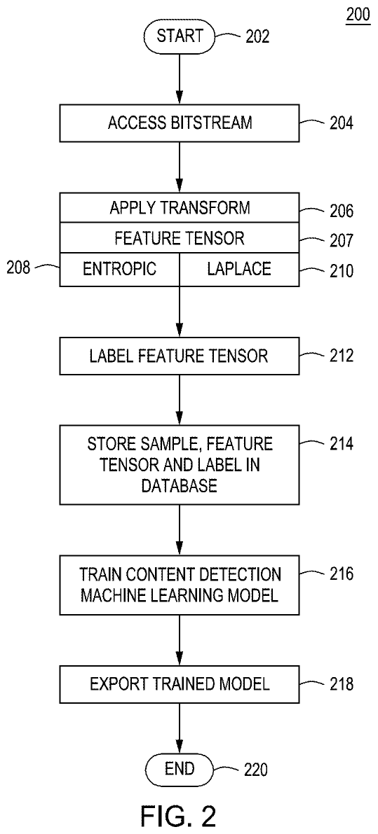

FIG. 2 illustrates an exemplary flow diagram representing one or more of the processes as described herein. Each block of the flow diagram may represent a module of code to execute and/or combinations of hardware and/or software configured to perform one or more processes described herein. Though illustrated in a particular order, the following figures are not meant to be so limiting. Any number of blocks may proceed in any order (including being omitted) and/or substantially simultaneously (i.e., within technical tolerances of processors, etc.) to perform the operations described herein.

FIG. 2 is a flow diagram of a method 200 for generating the machine learning model 116 of FIG. 1 in accordance with at least one embodiment of the present principles. The method 200 begins at 202 and proceeds to 204 where the method 200 accesses a bitstream (e.g., recalls a bitstream from memory or receives a streaming bitstream). The bitstream may be in the form of a file. The bitstream may comprise various forms of content (e.g., video, audio, images, text, executable code, and the like). At 206, the method 200 applies one or more transforms to the bitstream or portions of the bitstream. The transform(s) produces one or more feature tensors 207 that represents the content of the bitstream. In one embodiment, the transform produces a vector of entropies (entropic vector 208) to represent the bitstream or portion of the bitstream. In one exemplary embodiment, an entropic vector represents the entropy of the content within a, bitstream or data stream i.e., the variation of the content. In another exemplary embodiment, the transform may produce a Laplace matrix 210 representation of the bitstream content. The Laplace transform may use a sliding window to apply the transform to a bitstream, i.e., apply the transform to a bitstream or binary content. In further embodiments, both entropic and Laplacian transforms may be applied. Other embodiments may use other forms of transforms that produce feature tensors representing the content or portion of the content of a bitstream. When multiple transforms are used, in one embodiment, each transform produces a specific feature tensor, the multiple feature tensors may be combined to form a single feature tensor that represents various feature of the content in the bitstream or portion of the bitstream.

At 212, the method 200 labels the feature tensor(s) by the type of content the feature tensor represents. Dataset labels may include, but are not limited to, text, video, audio, executable code, image, and the like. Labels may be specific to malicious content such as malware, virus, ransomware, worms, trojans, spyware, keyloggers and the like. The labelling process may be automated, manual (e.g., human intervention) or a combination of both. At 214, the bitstream or portion of the bitstream containing the specific content related to the feature tensor, the feature tensor and its label are stored as a content sample in the dataset. In some embodiments, the other features or metadata regarding the bitstream may also be stored in the dataset.

At 216, the content detection machine learning model is trained using the dataset. At 218, the method exports the trained model to the user devices 102 for use by the content detector 122 of FIG. 1 to detect content. At 220, the method 200 ends.

FIG. 3 depicts a computer system 300 that can be utilized in various embodiments of the present invention to implement the computer and/or the display, according to one or more embodiments.

Various embodiments of method and system for generating a dataset for training a machine learning model, as described herein, may be executed on one or more computer systems, which may interact with various other devices. One such computer system is computer system 300 illustrated by FIG. 3, which may in various embodiments implement any of the elements or functionality illustrated in FIGS. 1 and 2. In various embodiments, computer system 300 may be configured to implement methods described above. The computer system 300 may be used to implement any other system, device, element, functionality or method of the above-described embodiments. In the illustrated embodiments, computer system 300 may be configured to implement the user devices 102, model generating computer 108 and server 106 and implement the method 200 as processor-executable executable program instructions 322 (e.g., program instructions executable by processor(s) 310) in various embodiments.

In the illustrated embodiment, computer system 300 includes one or more processors 310a-310n coupled to a system memory 320 via an input/output (I/O) interface 330. Computer system 300 further includes a network interface 340 coupled to I/O interface 330, and one or more input/output devices 350, such as cursor control device 360, keyboard 370, and display(s) 380. In various embodiments, any of the components may be utilized by the system to receive user input described above. In various embodiments, a user interface may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310 may be any suitable processor capable of executing instructions. For example, in various embodiments processors 310 may be general-purpose or embedded processors implementing any of a variety of instruction set architectures (ISAs). In multiprocessor systems, each of the processors 310 may commonly, but not necessarily, implement the same ISA.

System memory 320 may be configured to store program instructions 322 and/or data 332 accessible by processor 310. In various embodiments, system memory 320 may be implemented using any non-transitory computer readable media including any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one component (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. Also, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example, via digital fiber communications networks; via storage area networks such as Fiber Channel SANs, or via any other suitable type of network and/or protocol.

Input/output devices 350 may, in some embodiments, include one or more display terminals, keyboards, keypads, touchpads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

In some embodiments, the illustrated computer system may implement any of the operations and methods described above, such as the methods illustrated by the flowchart of FIG. 2. In other embodiments, different elements and data may be included.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description on a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

### Example Clauses

A. A method for generating a machine learning model comprising:
accessing a bitstream;
applying at least one transform to produce at least one feature tensor regarding at least a portion of the bitstream;
labeling the at least one feature tensor into at least one label, where the at least one label comprises a type of content represented by the at least one feature tensor; and
storing the at least one feature tensor, the at least one feature tensor label, and the at least a portion of the bitstream in a dataset.
   B. The method of clause A, further comprising using the dataset to train a machine learning model.
   C. The method of clauses A or B, wherein the type of content comprises at least one of video, audio, text, image, executable code, non-executable code, malware, corrupted code, or virus.
   D. The method of clauses A-C, wherein, after training, the machine learning model is capable of detecting and classifying content within other bitstreams.
   E. The method of clauses A-D, wherein the feature tensor comprises at least one of an entropic vector, a Laplace matrix, or n-gram.
   F. The method of clauses A-E, wherein the at least one feature tensor is indicative of content within the bitstream.
   G. The method of clauses A-F, wherein the content comprises at least one of video, text, executable code, non-executable code, malware, virus, corrupted content, or image.
   H. The method of clauses A-G, wherein the content comprises executable code and the at least one feature tensor represents features or functions of subroutines within the executable code.
   I. Apparatus for generating a machine learning model comprising at least one processor coupled to at least one non-transitory computer readable medium having instructions stored thereon, which, when executed by the at least one processor, cause the at least one processor to perform operations comprising:
accessing a bitstream;
applying at least one transform to produce at least one feature tensor regarding at least a portion of the bitstream;
labeling the at least one feature tensor into at least one label, where the at least one label comprises a type of content represented by the at least one feature tensor; and
storing the at least one feature tensor, the at least one feature tensor label, and the at least a portion of the bitstream in a dataset.
   J. The apparatus of clause I, wherein the operations further comprise using the dataset to train a machine learning model.
   K. The apparatus of clauses I or J, wherein the type of content comprises at least one of video, audio, text, image, executable code, non-executable code, malware, corrupted code, or virus.
   L. The apparatus of clauses I-K, wherein, after training, the machine learning model is capable of detecting and classifying content within other bitstreams and/or identifying boundaries between types of content within a bitstream.
   M. The apparatus of clauses I-L, wherein the feature tensor comprises at least one of an entropic vector, a Laplace matrix, or n-gram.
   N. The apparatus of clauses I-M, wherein the at least one feature tensor is indicative of content within the bitstream.
   O. The apparatus of clauses I-N, wherein the content comprises at least one of video, text, executable code, non-executable code, malware, virus, corrupted content, or image.
   P. The apparatus of clauses I-N, wherein the content comprises executable code and the at least one feature tensor represents features or functions of subroutines within the executable code.
   Q. A method for generating a malware detection machine learning model comprising:
accessing a bitstream comprising non-executable malware;
applying a transform to produce a feature tensor regarding at least a portion of the bitstream that contains non-executable malware; and
labeling the feature tensor into a malware label;
storing the feature tensor, the malware label, and the at least a portion of the bitstream in a dataset.
   R. The method of clause Q further comprising using the dataset to train a machine learning model to detect non-executable malware.
   S. The method of clause Q or R, wherein the feature tensor comprises at least one of an entropic vector, a Laplace matrix or and n-gram.
   T. The method of clauses Q-S, wherein the bitstream comprises executable malware.

What is claimed is:

1. A method for generating a machine learning model comprising:
accessing a bitstream;
applying at least one transform to produce at least one feature tensor regarding at least a portion of the bitstream;
labeling the at least one feature tensor into at least one label, where the at least one label comprises a type of content represented by the at least one feature tensor; and
storing the at least one feature tensor, the at least one feature tensor label, and the at least a portion of the bitstream in a dataset.

2. The method of claim 1, further comprising using the dataset to train a machine learning model.

3. The method of claim 2, wherein the type of content comprises at least one of video, audio, text, image, executable code, non-executable code, malware, corrupted code, or virus.

4. The method of claim 3, wherein, after training, the machine learning model is capable of detecting and classifying content within other bitstreams.

5. The method of claim 1, wherein the feature tensor comprises at least one of an entropic vector, a Laplace matrix, or n-gram.

6. The method of claim 1, wherein the at least one feature tensor is indicative of content within the bitstream.

7. The method of claim 6, wherein the content comprises at least one of video, text, executable code, non-executable code, malware, virus, corrupted content, or image.

8. The method of claim 6, wherein the content comprises executable code and the at least one feature tensor represents features or functions of subroutines within the executable code.

9. Apparatus for generating a machine learning model comprising at least one processor coupled to at least one non-transitory computer readable medium having instructions stored thereon, which, when executed by the at least one processor, cause the at least one processor to perform operations comprising:
accessing a bitstream;
applying at least one transform to produce at least one feature tensor regarding at least a portion of the bitstream;
labeling the at least one feature tensor into at least one label, where the at least one label comprises a type of content represented by the at least one feature tensor; and
storing the at least one feature tensor, the at least one feature tensor label, and the at least a portion of the bitstream in a dataset.

10. The apparatus of claim 9, wherein the operations further comprise using the dataset to train a machine learning model.

11. The apparatus of claim 10, wherein the type of content comprises at least one of video, audio, text, image, executable code, non-executable code, malware, corrupted code, or virus.

12. The apparatus of claim 11, wherein, after training, the machine learning model is capable of detecting and classifying content within other bitstreams and/or identifying boundaries between types of content within a bitstream.

13. The apparatus of claim 9, wherein the feature tensor comprises at least one of an entropic vector, a Laplace matrix, or n-gram.

14. The apparatus of claim 9, wherein the at least one feature tensor is indicative of content within the bitstream.

15. The apparatus of claim 14, wherein the content comprises at least one of video, text, executable code, non-executable code, malware, virus, corrupted content, or image.

16. The apparatus of claim 15, wherein the content comprises executable code and the at least one feature tensor represents features or functions of subroutines within the executable code.

17. A method for generating a malware detection machine learning model comprising:
accessing a bitstream comprising non-executable malware;
applying a transform to produce a feature tensor regarding at least a portion of the bitstream that contains non-executable malware; and
labeling the feature tensor into a malware label;
storing the feature tensor, the malware label, and the at least a portion of the bitstream in a dataset.

18. The method of claim 17 further comprising using the dataset to train a machine learning model to detect non-executable malware.

19. The method of claim 17, wherein the feature tensor comprises at least one of an entropic vector, a Laplace matrix or and n-gram.

20. The method of claim 17, wherein the bitstream comprises executable malware.
